(19) United States
(12) Patent Application Publication
(10) Pub. No.: US 2024/0176325 A1
(43) Pub. Date: May 30, 2024

(54) SYSTEM AND METHOD FOR PREDICTING AI USEFUL LIFE BASED ON ACCELERATED LIFE TESTING DATA

(71) Applicant: Electronics and Telecommunications Research Institute, Daejeon (KR)

(72) Inventors: Nack Woo Kim, Daejeon (KR); Byung-Tak Lee, Daejeon (KR); JUNGI LEE, Daejeon (KR); Hyun Yong Lee, Daejeon (KR); Yumin HWANG, Daejeon (KR)

(73) Assignee: Electronics and Telecommunications Research Institute, Daejeon (KR)

(21) Appl. No.: 18/209,918

(22) Filed: Jun. 14, 2023

(30) Foreign Application Priority Data
Nov. 24, 2022 (KR) 10-2022-0159028

(51) Int. Cl. G05B 19/4065

(52) U.S. Cl. CPC G05B 19/4065; G05B 2219/50185

(57) ABSTRACT

The present invention relates to a system and method for predicting AI useful life based on accelerated life testing data. The system for predicting AI useful life based on accelerated life testing data according to the present invention includes a feature extraction unit configured to receive accelerated life training data and actual operation testing result and encodes the received accelerated life training data and actual operation testing result into a latent variable, a regression network configured to be branched for each domain of data received by the feature extraction unit, and a domain discrimination network configured to map the accelerated life training data and actual operation testing result to the latent variables in a latent space.

### CROSS-REFERENCE TO RELATED APPLICATION

This application claims priority to and the benefit of Korean Patent Application No. 10-2022-0159028 filed on Nov. 24, 2022, the disclosure of which is incorporated herein by reference in its entirety.

### BACKGROUND

### 1. Field

The present invention relates to a system and method for predicting AI useful life based on accelerated life testing data.

### 2. Description of Related Art

Life is defined as a period during which an object withstands use, and a life prediction technology is a technology that continuously monitors a status of facilities or devices using various sensors and is a major technology that improves system reliability and equipment operation efficiency by predicting life through pre-diagnosis of signs of failure.

According to the related art, in predicting the life of mechanical parts or electronic devices, there is a problem in that it is difficult to accurately know a life estimation model, and it is difficult to determine a distribution function according to distribution characteristics of life data, and there is a problem in that, when applying artificial intelligence-based deep learning techniques, not only learning is difficult, but also predictive performance of result inference deteriorates.

### SUMMARY

The present provides a system and method for predicting AI useful life based on accelerated life testing capable of predicting life regardless of a life distribution model or a life model, with acceleration according to an accelerated life test as a limiting condition.

In an aspect of the present invention, a system for predicting AI useful life based on accelerated life testing data includes: a feature extraction unit configured to receive accelerated life training data and actual operation testing result and encodes the received accelerated life training data and actual operation testing result into a latent variable; a regression network configured to be branched for each domain of data received by the feature extraction unit; and a domain discrimination network configured to map the accelerated life training data and actual operation testing result to the latent variables in a latent space.

The feature extraction unit may receive data according to accelerated variable setting, receive data of a first domain, in which a correct life value exists, as the accelerated life training data, and receive data of a second domain for which life prediction is required as the actual operation testing result.

The regression network may share a slope weight parameter value in the same layer of the branched networks for each of a plurality of domains included in the first domain.

The regression network may perform learning by limiting a numerical range so that intercept parameter values are listed in descending order in the same layer of the branched networks for each of a plurality of domains included in the first domain.

The regression network may share an intercept parameter value in the same layer of the branched networks for each of a plurality of domains included in the first domain.

The domain discrimination network may perform adversarial learning to recognize the first domain and the second domain as one domain.

The feature extraction unit may calculate a parameter of the second domain by using an intercept value distance in a preset layer of the branched networks for each of a plurality of domains included in the first domain, and predict the life of data of the second domain.

In another aspect of the present invention, a method of predicting AI useful life based on accelerated life testing data performed by the system for predicting AI useful life based on accelerated life testing data includes: (a) receiving a data sensing value and a final life value for a life prediction target device for each domain according to accelerated variable setting; (b) applying an adversarial learning model to the data sensing value having different cluster characteristics for each domain and converting the data sensing value into a latent variable; (c) performing life prediction learning for each domain by referring to constraints on a slope weight parameter and an intercept parameter of the regression network; and (d) calculating a distance of a life distribution estimation line for the domain and setting a parameter of a branched regression network for testing result.

In the (c), learning may be performed by limiting a numerical range so that intercept parameter values are listed in descending order in the same layer of the branched networks for each domain.

In the (d), the parameter of the branched regression network for the testing result may be set using an intercept value distance in a preset layer of the branched networks for each domain, and life prediction under a target condition may be performed.

An apparatus for predicting AI useful life based on accelerated life testing data includes: an input interface device configured to receive accelerated life training data and actual operation testing result; a memory configured to store a program that predicts life of a device by applying an adversarial deep learning model based on acceleration constraints; and a processor configured to execute the program, in which the processor may perform life prediction using the actual operation testing result based on a difference between intercepts calculated for each domain on a life distribution estimation line which is an accelerated life testing result.

The input interface device may receive data according to the accelerated variable setting, receive data of a first domain, in which a correct life value exists, as the accelerated life training data by an accelerated life test, and receive data of a second domain for which life prediction is required as the actual operation testing result.

The processor may perform life prediction using branched regression networks for each domain of data received by the input interface device, and the regression network may share a slope weight parameter value in the same layer of the branched networks for each of a plurality of domains included in the first domain.

The processor may perform learning by limiting a numerical range so that intercept parameter values are listed in descending order in the same layer of the branched networks for each of a plurality of domains included in the first domain.

The processor may perform adversarial learning to recognize the first domain and the second domain as one domain.

The processor may readjust a learning parameter of the second domain by confirming a linear relationship between a slope weight parameter and a difference between the intercepts.

### BRIEF DESCRIPTION OF DRAWINGS

FIG. 1 is a diagram illustrating a configuration of a life prediction model based on accelerated life testing data according to an embodiment of the present invention.

FIG. 2 is a diagram illustrating a regression network according to an embodiment of the present invention.

FIG. 3 is a diagram illustrating a pseudocode notation of a training learning procedure for life prediction according to an embodiment of the present invention.

FIG. 4 is a diagram illustrating a data processing process of a feature extraction unit based on a domain discrimination network according to an embodiment of the present invention.

FIG. 5 is a diagram illustrating a life distribution estimation line as a result of an accelerated life test according to an embodiment of the present invention.

FIG. 6 is a diagram illustrating estimation of temperature-life time correlation as a result of an accelerated life test under temperature conditions obtained by linear transformation.

FIG. 7 is a diagram illustrating a flowchart of training of a life prediction model based on accelerated life testing data according to an embodiment of the present invention.

FIG. 8 is a diagram illustrating a flowchart of a life prediction model test based on accelerated life testing data according to an embodiment of the present invention.

FIG. 9 is a block diagram illustrating a computer system for implementing the method according to the embodiment of the present invention.

### DETAILED DESCRIPTION

The above-mentioned aspect, and other aspects, advantages, and features of the present disclosure and methods accomplishing them will become apparent from the following detailed description of exemplary embodiments with reference to the accompanying drawings.

However, the present invention may be modified in many different forms and it should not be limited to the exemplary embodiments set forth herein, and only the following embodiments are provided to easily inform those of ordinary skill in the art to which the present invention pertains the objects, configurations, and effects of the present invention, and the scope of the present invention is defined by the description of the claims.

Meanwhile, terms used in the present specification are for explaining exemplary embodiments rather than limiting the present invention. Unless otherwise stated, a singular form includes a plural form in the present specification. “Comprises” and/or “comprising” used in the present invention indicate (s) the presence of stated components, steps, operations, and/or elements but do(es) not exclude the presence or addition of one or more other components, steps, operations, and/or elements.

Life means expected life until the failure of electronic products, machines, equipment parts, etc., is repaired and may be represented by time, cycle, distance, and the like. Under normal conditions, new products and parts are designed to be used without failure for decades or more. Therefore, a product life test under actual use conditions is almost impossible in terms of time and cost. A method of acquiring life data more quickly through an accelerated test in an environment harsher than actual use conditions and applying the acquired life data to an accelerated model is used.

Life prediction technology is a core field of Prognostics & Health Management technology, and is one of the main technologies that continuously monitors a status of facilities, devices, or the like through various sensors and predicts life through pre-diagnosis of signs of failure to increase system reliability and device operation efficiency.

The life prediction technology according to the related art has a problem in that it is difficult to accurately know a life estimation model of a mechanical part or an electronic device whose life is to be predicted. In order to estimate life in real environments through the accelerated life tests in various environments, a life-stress relational expression such as an Arrhenius model, an inverse model, and an Eyring model should be established through life testing result analysis. However, since the application of the model should be different depending on the feature values to be observed, there is a problem in that improper model selection may easily cause incorrect results.

The life prediction technology according to the related art has a problem in that it is difficult to determine a distribution function according to the distribution characteristics of the life data. For example, in order to analyze accidental failure characteristics due to excessive stress, life distribution functions such as a Weibull distribution, an exponential distribution, a lognormal distribution, and a normal distribution are determined according to failure data, and a reliability scale is estimated. That is, it is necessary to analyze whether the failure data is symmetrical, whether a failure rate is increasing, and the like, and apply a parametric shape to the analyzed result, but since the distribution function to be applied and the actual data distribution do not match each other, there is a problem in that it is not suitable and practical use becomes difficult.

In relation to the life prediction technology according to the related art, an attempt was made to apply an artificial intelligence-based deep learning technique rather than an accelerated life test-based life estimation model. However, there is a problem in that, since the number of actual operational data from the initial normal state to the occurrence of failure is very small, it is difficult to learn, and the predictive performance is greatly reduced to infer results by inputting actual operational data to the trained model even if the deep learning model is trained with the accelerated life testing data due to the large difference in data characteristics between the accelerated life testing data and production data.

The accelerated life test aims to find regular failure mechanisms for product life characteristics or failure rates, either through accelerated utilization or high stress imposition. By performing a small number of accelerated tests for a short period of time, a model for the change in the amount of deterioration of a product or part is established, and the life under actual use conditions is measured from the estimated model. Representative life models include the Arrhenius model, the inverse model, the Eyring model, and the like, and the acceleration conditions need to be established for reliable data analysis.

The acceleration means that, even if a product is subjected to severe stress step by step, a new failure different from the accelerated test in the previous step does not occur, and the failure mode that occurred in the accelerated test in the previous step is reproduced in the same way. When the life distribution of actual use conditions and accelerated test conditions are linear life estimation functions with different intercepts (parameter b), and at the same time the life estimation functions are listed in descending order according to the severe stress conditions, the acceleration is said to be established.

Since it is common for the failure rate of a product to gradually increase over time, the Weibull distribution is generally used for measurement data. Since the shape parameter of the Weibull distribution represents the slope of the life distribution estimation line, in order to confirm the establishment of acceleration, it is necessary to confirm the slope of the linear function listed in parallel according to the severe stress conditions and order. In addition to the Weibull distribution, an exponential distribution, a lognormal distribution, a normal distribution, and the like are used for the life distribution of data according to failure.

The life prediction technology, which is universally widely used, performs the accelerated test based on multiple samples in various environments to acquire life data, selects a specific model according to the change in the amount of deterioration in the target product or part, and sets a distribution model according to the distribution characteristics of life data to perform life prediction.

Even if a universally widely used model is selected through the accelerated life test, wrong conclusions may be drawn if an inappropriate life distribution model that does not fit the distribution characteristics of the data is selected. In addition, it should be ensured that failure modes that do not appear in consumer use conditions do not occur in the accelerated test, and the failure mode and mechanism under the use conditions and accelerated conditions need to satisfy the constraints that should remain the same.

Therefore, a data-based artificial intelligence learning technique capable of predicting life regardless of the life distribution model or the life model, with the acceleration according to the accelerated life test as the constraints, is required. According to an embodiment of the present invention, life is predicted through an adversarial deep learning technique based on accelerated life testing data of mechanical parts or electronic devices, with acceleration having linear characteristics as constraints.

According to the acceleration constraints, even if stress is imposed on the product step by step, in the environment where the failure mode that occurred in the accelerated test in the previous step is identically reproduced, the result that the slope of the life distribution estimation line is listed in order according to the step-by-step stress imposition is realized. According to an embodiment of the present invention, by using the accelerated life testing data for which the acceleration constraints are satisfied as the training data for the adversarial deep learning model, the life may be estimated through the model learning only based on data without worrying about the life estimation model or the life data distribution characteristics. According to the embodiment of the present invention, there is a technical feature capable of solving different data feature problems between the accelerated life testing data and the actual operational data in a domain-adaptive way through the accelerated constraints and the adversarial deep learning model.

The accelerated life test is an experiment that increases the frequency or speed of failure compared to normal use conditions by severely imposing conditions such as temperature, humidity, pressure, vibration, load, and speed on target items. In the detailed description of the present invention, temperature conditions are assumed and described to help those skilled in the art understand. Different domains A, B, C, and D refer to accelerated life data with different temperature conditions, and A, B, C, and D are listed in descending order according to the temperature conditions.

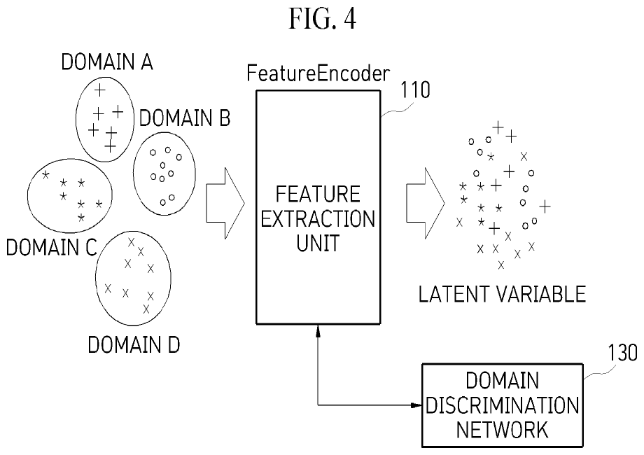

Referring to FIG. 4, in the case of 175° C., 135° C., 95° C., and 55° C. life data test, in order to satisfy the acceleration conditions, A, B, C, D domains are set, and the data of the deep learning model needs to be input in this order. The number of input domains and the number of branched regression networks for each domain are determined according to the accelerated life conditions. Hereinafter, three stages of accelerated life test temperature conditions and one stage of actual operating temperature conditions will be assumed and described.

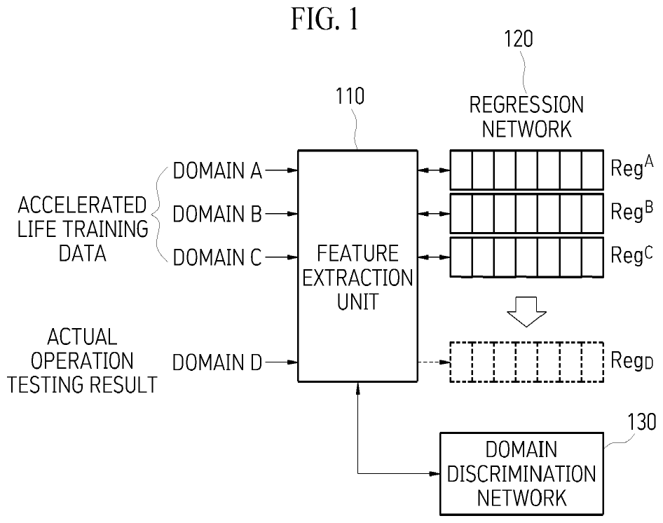

FIG. 1 is a diagram illustrating a configuration of a life prediction model based on accelerated life testing data according to an embodiment of the present invention.

The life prediction model according to the embodiment of the present invention includes a feature extraction unit 110 that encodes the input data into a latent variable, a branched regression network 120 for each domain to predict the life of accelerated life data, and a domain discrimination network 130 that maps both training data and testing data to latent variables in similar cluster regions in a latent space.

Referring to FIG. 1, the accelerated life data with different temperature conditions are divided for each domain, the domains A to C are divided as training data, and the domain D is divided as testing data. In this case, the domain A to domain C data is data for which a correct life value exists by the accelerated life test, and the domain D data is actual operational data, which does not have a separate correct value and requires life prediction.

As the input of the feature extraction unit 110, each domain input data is subdivided and concatenated to be used as a batch structure. The output of the feature extraction unit 110 accepts all of the inverse weight learning that minimizes the inter-domain cluster discrimination performance based on the adversarial learning in the domain discrimination network 130 along with the update of the weight parameter for minimizing the prediction loss in the connected regression network 120. By using the latent variables output from the feature extraction unit 110, the prediction accuracy for each domain is improved and at the same time, reverse learning for domain discrimination is performed so that each domain may be recognized as one domain.

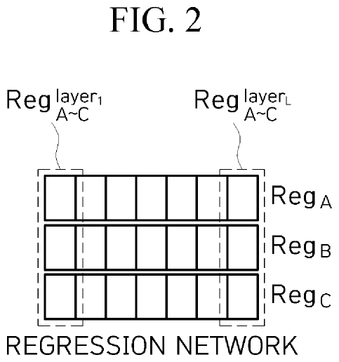

FIG. 2 illustrates a regression network according to an embodiment of the present invention.

The gradient weight parameter w of the regression network 120 shares parameter values in the same layer j, that is, Reg_{A˜C}^{layer}^{ⱼ} of the branched regression network {Reg_{A}, Reg_{B}, Reg_{C}} for each domain.

The intercept parameter b is trained by limiting the numerical range so that the parameter values may be listed in descending order in Reg_{A˜C}^{layer}^{ⱼ}.

An intercept value b{Reg_{A}^{layer}^{ⱼ}} of layer j in branched regression network A is greater than the intercept value b{Reg_{B}^{layer}^{ⱼ}} of layer j in branched regression network B, and finally, the learning is performed by limiting the numerical range of b so that it may be listed in descending order of b{Reg_{A}^{layer}^{ⱼ}}>b{Reg_{B}^{layer}^{ⱼ}}>b{Reg_{C}^{layer}^{ⱼ}. Through the above training, the acceleration constraints are given to the life model. The parameters (gradient weight parameter w, intercept parameter b) of the branched regression network for each domain may be limited to be shared or not shared according to learning constraints. As an example, it is possible to share both the w parameter on the same layer Reg_{A˜C}^{layer}^{ⱼ} of the branched regression network for each domain and the b parameter for each same layer, but perform learning to list only the b parameter of the final layer in descending order without sharing each other. As another example, it is possible to share all w parameters on the same layer Reg_{A˜C}^{layer}^{ⱼ} of the branched regression networks for each domain, and perform learning to list the b parameters in descending order for each same layer. As another example, the w parameters on the final layer Reg_{A˜C}^{layer}^{_{L}} of the branched regression network for each domain are shared with each other. In this case, the b parameters are learned to be listed in descending order, but the w and b parameters in the remaining layers except for the final layer may not have any constraints.

Hereinafter, the embodiment of the present invention will be described based on the above-described embodiment (the w parameters on the same layer Reg_{A˜C}^{layer}^{ⱼ} of the branched regression networks for each domain and the b parameters for each layer are all shared, but only the b parameter of the final layer is learned to be listed in descending order without share each other).

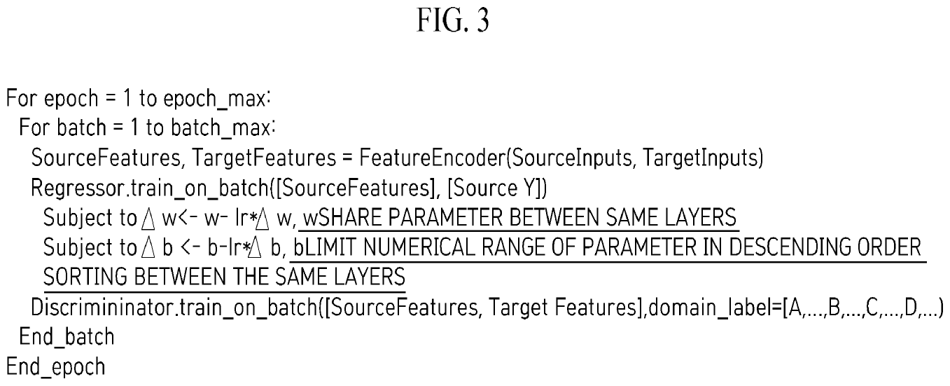

The training learning procedure for the life prediction can be expressed in pseudocode as illustrated in FIG. 3.

FIG. 4 illustrates a data processing process of a feature extraction unit based on a domain discrimination network according to an embodiment of the present invention.

During training, all values of the domains A to D are input to the life model, and the model is learned in a direction that minimizes the prediction loss of the branched regression networks of the domains A to C, and at the same time the adversarial learning is performed so that the cluster areas of each domain A to D are not separately recognized, that is, recognized as one domain data in the domain discrimination network 130.

The slope weight parameter w of the regression network is shared with each other in the same layer, and the learning is performed by limiting the numerical range of the intercept parameter b so that it is listed in descending order in the final layer according to the domain order.

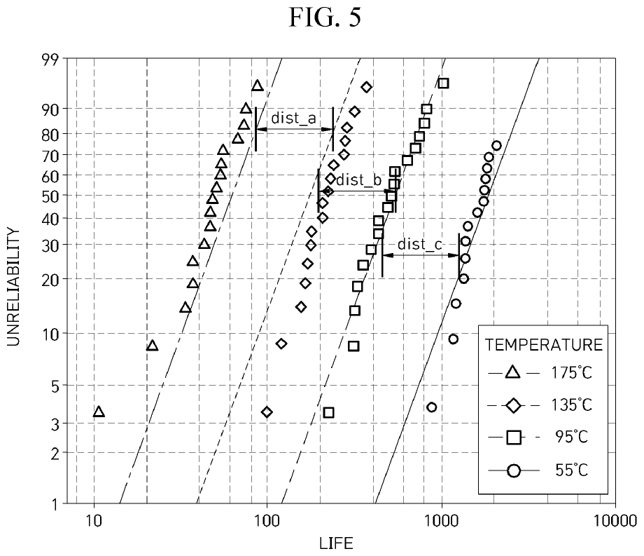

FIG. 5 illustrates an accelerated life test result life distribution estimation line according to an embodiment of the present invention.

A distance between an intercept value in layer L of the branched regression network A and an intercept value in layer L of branched regression network B is represented by dist_a=dist|b{Reg_{A}^{layer}^{_{L}}}−b{Reg_{B}^{layer}^{_{L}}}|, and in the same way, a distance between an intercept value in layer L of the branched regression network B and an intercept value in layer L of the branched regression network C is represented by dist_b=dist|b{Reg_{B}^{layer}^{_{L}}}−b{Reg_{C}^{layer}^{_{L}}}|.

As a result of life prediction model training through the training data of the domains A to C, each parameter of the branched regression network for each domain A to C is learned, and it is possible to predict the life of the domain D testing data through the regression network Reg_{D} for domain D using the learned parameters.

The same layer j, that is, Reg_{A˜C}^{layer}^{ⱼ} of the learning parameters {Reg_{A}, Reg_{B}, Reg_{C}} of the untrained regression network Reg_{D} is used.

A method of sharing both the slope parameter w and the intercept parameter b for each same layer of Reg_{C} and equally sharing w for Reg_{D} in a final layer, but obtaining the parameter b of the Reg_{D} by inferring dist_c using dist_a and dist_b may be applied.

For the dist_c, a maximum value dist_{c}=max(dist_a,dist_b) dist_c=avg (dist_a,dist_b), an average value, dist_c=min (dist_a,dist_b) a minimum value, etc., between the dist_a and the dist_b may be applied universally. Also, depending on the correlation between the dist_a and the dist_b, it is possible to perform a calculation by applying a logarithmic scale or the like to each of the dist_a and dist_b, or to relatively infer the dist_c value by applying a geometric sequence.

b{Reg_{D}^{layer}^{_{L}}} satisfying the constraints b{Reg_{A}^{layer}^{_{L}}}>b{Reg_{B}^{layer}^{_{L}}}>b{Reg_{C}^{layer}^{_{L}}}>b{Reg_{D}^{layer}^{_{L}}} through the dist_c may be obtained through the difference between b{Reg_{C}^{layer}^{_{L}}} and the dist_c, and is substituted into the parameter b of the final layer.

Through the above-described process, the learning parameter of the Reg_{D} is obtained from Reg_{A} to Reg_{C}, and the life prediction value is derived as a result of the branched regression network Reg_{D} with respect to the input of the actual operation testing data domain D.

FIG. 5 illustrates an example of estimating the life distribution lines at 175° C., 135° C., 95° C., and 55° C. through the result value of the branched regression networks Reg_{A} to Reg_{D} of the life prediction model.

The slope of the life distribution line becomes the value of the slope weight parameter w of the life prediction model, and the intercept becomes the value of the parameter b of the life prediction model. In order to satisfy the acceleration condition, the accelerated test condition in the target item must be arranged in descending order, and the intercept value is also arranged in descending order accordingly.

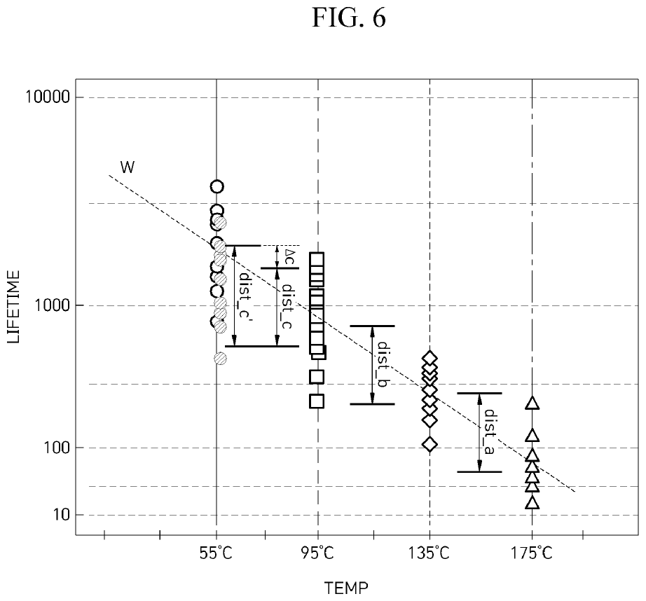

In the life distribution estimation line, the difference between the intercepts are represented by the dist_a, dist_b, and dist_c, and FIG. 6 illustrates these results through linear transformation.

FIG. 6 illustrates the accelerated life test result temperature-life time correlation estimation under the temperature conditions acquired by the linear transformation.

Referring to FIG. 6, the dist_a, dist_b, and dist_c in each life test condition may be confirmed, and when it is confirmed that the linear relationship between the slope weight parameter w and the dist_a, dist_b, and dist_c does not clearly fit as in the 55° C. gray sample distribution in FIG. 6, a difference value is corrected with dist_c′ to which Δc is added to readjust the learning parameter b of Reg_{D} so that a 55° C. black sample distribution appears.

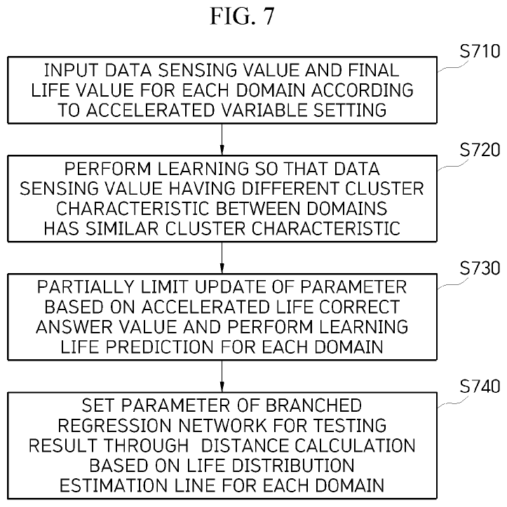

FIG. 7 illustrates a flowchart of training of a life prediction model based on accelerated life testing data according to an embodiment of the present invention.

In step S710, training data of domains A to D according to accelerated variable settings such as temperature, humidity, pressure, vibration, load, and speed are input. In this case, among the training data, the domains A to C data are input together with correct values so that the life may be predicted through the regression network.

In step S720, the input training data is converted into latent variables that enable life prediction through a regression network while having similar cluster characteristics between domains through learning of a feature extraction unit and a domain discrimination network.

In step S730, the regression network performs learning to minimize an accelerated life correct answer loss value while partially limiting the update of the w and b parameters of the regression network in order to satisfy the acceleration constraints.

In step S740, after the learning ends, dist_c is calculated through dist_a and dist_b of the domains A to C, and the estimated w and b parameters are input to the branched regression network of the domain D.

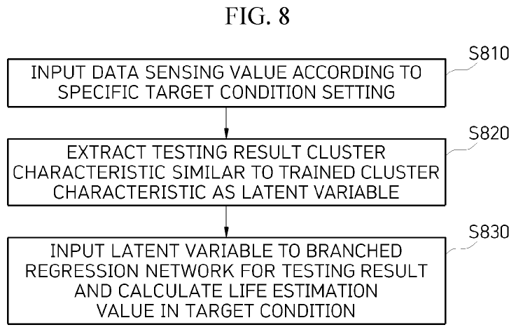

FIG. 8 illustrates a flowchart of a life prediction model test based on accelerated life testing data according to an embodiment of the present invention.

In step S810, for life prediction under a specific target condition (e.g., 55° C. temperature condition), the data sensing value under the corresponding condition is input.

In step S820, a latent variable having cluster characteristics similar to the training data is extracted through the feature extraction unit.

In step S830, the extracted latent variables are input to the branched regression network of the domain D, and the life estimation values are calculated.

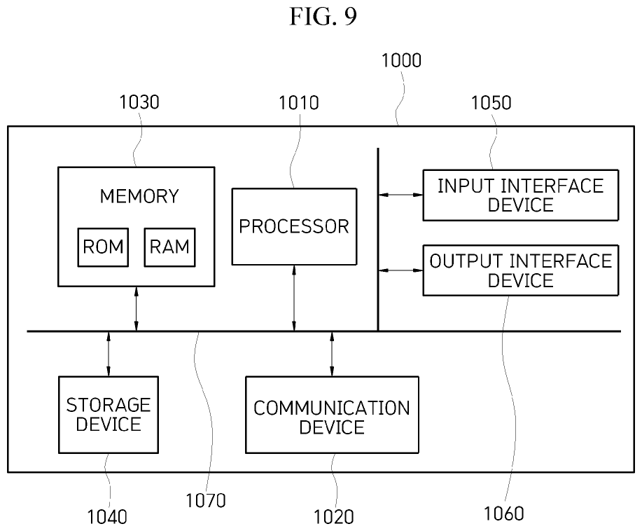

FIG. 9 is a block diagram illustrating a computer system for implementing the method according to the embodiment of the present invention.

Referring to FIG. 9, a computer system 1000 may include at least one of a processor 1010, a memory 1030, an input interface device 1050, an output interface device 1070, and a storage device 1040 that communicate through a bus 1070. The computer system 1000 may also include a communication device 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random access memory (RAM). In the embodiment of the present disclosure, the memory may be located inside or outside the processing unit, and the memory may be connected to the processing unit through various known means. The memory may be various types of volatile or non-volatile storage media, and the memory may include, for example, a ROM or a RAM.

An apparatus for predicting AI useful life based on accelerated life testing data according to an embodiment of the present invention includes an input interface device 1050 that receives accelerated life training data and actual operation testing result, a memory 1030 that stores a program for predicting life of a device by applying an adversarial deep learning model based on acceleration constraints, and a processor 1010 that executes a program, in which the processor 1010 performs the life prediction using the actual operation testing result based on the difference between intercepts calculated for each domain on the life distribution estimation line which is the accelerated life testing result.

The input interface device 1050 receives data according to the accelerated variable setting, receives data of a first domain, in which a correct life value exists, as the accelerated life training data by an accelerated life test, and receives data of a second domain for which life prediction is required as the actual operation testing result.

The processor 1010 performs life prediction using branched regression networks for each domain of data received by the input interface device 1050, and the regression network shares a slope weight parameter value in the same layer of the branched networks for each of the plurality of domains included in the first domain.

The processor 1010 performs learning by limiting a numerical range so that the intercept parameter values are listed in descending order in the same layer of the branched networks for each of the plurality of domains included in the first domain.

The processor 1010 performs adversarial learning to recognize the first domain and the second domain as one domain.

The processor 1010 readjusts the learning parameters of the second domain by confirming the linear relationship between the slope weight parameter and the difference between the intercepts.

The embodiment of the present invention may be implemented as a computer-implemented method, or as a non-transitory computer-readable medium having computer-executable instructions stored thereon. In one embodiment, when executed by the processing unit, the computer-readable instructions may perform the method according to at least one aspect of the present disclosure.

The communication device 1020 may transmit or receive a wired signal or a wireless signal.

In addition, the method according to the embodiment of the present invention may be implemented in a form of program instructions that may be executed through various computer means and may be recorded in a computer-readable recording medium.

The computer-readable recording medium may include a program instruction, a data file, a data structure or the like, alone or a combination thereof. The program instructions recorded in the computer-readable recording medium may be configured by being especially designed for the embodiment of the present invention, or may be used by being known to those skilled in the field of computer software. The computer-readable recording medium may include a hardware device configured to store and execute the program instructions. Examples of the computer-readable recording medium may include magnetic media such as a hard disk, a floppy disk, and a magnetic tape, optical media such as a compact disk read only memory (CD-ROM) or a digital versatile disk (DVD), magneto-optical media such as a floptical disk, a ROM, a RAM, a flash memory, or the like. Examples of the program instructions may include a high-level language code capable of being executed by a computer using an interpreter, or the like, as well as a machine language code made by a compiler.

According to the present invention, in predicting life of mechanical parts or electronic devices, it is possible to perform life estimation based only on accelerated life testing data without considering a separate life estimation model or life data distribution characteristics through an application of an adversarial deep learning model based on acceleration constraints.

According to the present invention, by applying an adversarial learning model, it is possible to solve the problem of different data characteristics between accelerated life testing data for deep learning model training and actual operational data for life inference in the real environment, and increase predictive validity of data having different characteristics.

According to the present invention, it is possible to easily obtain a life estimation result in an operating environment to be obtained by modifying some learning parameters of a deep learning model without mathematical consideration of acceleration conditions, use condition distribution, life-stress relationship, etc., when a life estimation model is applied.

The effects of the present invention are not limited to those mentioned above, and other effects not mentioned can be clearly understood by those skilled in the art from the following description.

Although embodiments of the present invention have been described in detail hereinabove, the scope of the present invention is not limited thereto, but may include several modifications and alterations made by those skilled in the art using a basic concept of the present invention as defined in the claims.

What is claimed is:

1. A system for predicting AI useful life based on accelerated life testing data, comprising:
a feature extraction unit configured to receive accelerated life training data and actual operation testing result and encodes the received accelerated life training data and actual operation testing result into a latent variable;
a regression network configured to be branched for each domain of data received by the feature extraction unit; and
a domain discrimination network configured to map the accelerated life training data and actual operation testing result to the latent variables in a latent space.

2. The system of claim 1, wherein the feature extraction unit receives data according to accelerated variable setting, receives data of a first domain, in which a correct life value exists, as the accelerated life training data, and receives data of a second domain for which life prediction is required as the actual operation testing result.

3. The system of claim 2, wherein the regression network shares a slope weight parameter value in the same layer of the branched networks for each of a plurality of domains included in the first domain.

4. The system of claim 2, wherein the regression network performs learning by limiting a numerical range so that intercept parameter values are listed in descending order in the same layer of the branched networks for each of a plurality of domains included in the first domain.

5. The system of claim 2, wherein the regression network shares an intercept parameter value in the same layer of a branched network for each of a plurality of domains included in the first domain.

6. The system of claim 2, wherein the domain discrimination network performs adversarial learning to recognize the first domain and the second domain as one domain.

7. The system of claim 2, wherein the feature extraction unit calculates a parameter of the second domain by using an intercept value distance in a preset layer of the branched networks for each of a plurality of domains included in the first domain, and predicts the life of data of the second domain.

8. A method of predicting AI useful life based on accelerated life testing data performed by the system for predicting AI useful life based on accelerated life testing data, the method comprising:
(a) receiving a data sensing value and a final life value for a life prediction target device for each domain according to accelerated variable setting;
(b) applying an adversarial learning model to the data sensing value having different cluster characteristics for each domain and converting the data sensing value into a latent variable;
(c) performing life prediction learning for each domain by referring to constraints on a slope weight parameter and an intercept parameter of the regression network; and
(d) calculating a distance of a life distribution estimation line for the domain and setting a parameter of a branched regression network for testing result.

9. The method of claim 8, wherein, in the (c), learning is performed by limiting a numerical range so that intercept parameter values are listed in descending order in the same layer of the branched networks for each domain.

10. The method of claim 8, wherein, in the (d), the parameter of the branched regression network for the testing result is set using an intercept value distance in a preset layer of the branched networks for each domain, and life prediction under a target condition is performed.

11. An apparatus for predicting AI useful life based on accelerated life testing data, comprising:
an input interface device configured to receive accelerated life training data and actual operation testing result;
a memory configured to store a program that predicts life of a device by applying an adversarial deep learning model based on acceleration constraints; and
a processor configured to execute the program,
wherein the processor performs life prediction using the actual operation testing result based on a difference between intercepts calculated for each domain on a life distribution estimation line which is an accelerated life testing result.

12. The apparatus of claim 11, wherein the input interface device receives data according to the accelerated variable setting, receives data of a first domain, in which a correct life value exists, as the accelerated life training data by an accelerated life test, and receives data of a second domain for which life prediction is required as the actual operation testing result.

13. The apparatus of claim 12, wherein the processor performs life prediction using branched regression networks for each domain of data received by the input interface device, and the regression network shares a slope weight parameter value in the same layer of the branched networks for each of a plurality of domains included in the first domain.

14. The apparatus of claim 12, wherein the processor performs learning by limiting a numerical range so that intercept parameter values are listed in descending order in the same layer of the branched networks for each of a plurality of domains included in the first domain.

15. The apparatus of claim 12, wherein the processor performs adversarial learning to recognize the first domain and the second domain as one domain.

16. The apparatus of claim 12, wherein the processor readjusts a learning parameter of the second domain by confirming a linear relationship between a slope weight parameter and a difference between the intercepts.
